(19) United States
(12) Patent Application Publication
(10) Pub. No.: US 2013/0126599 A1
(43) Pub. Date: May 23, 2013

(54) SYSTEMS AND METHODS FOR CAPTURING CODES AND DELIVERING INCREASINGLY INTELLIGENT CONTENT IN RESPONSE THERETO

(71) Applicant: SmartCodeFX Solutions, Inc., Vancouver, WA (US)

(72) Inventors: Josh Soske, Vancouver, WA (US); Julian Gresser, Santa Barbara, CA (US); Rowland Hanson, Santa Barbara, CA (US)

(73) Assignee: SmartCodeFX Solutions, Inc., Vancouver, WA (US)

(21) Appl. No.: 13/675,533

(22) Filed: Nov. 13, 2012

Related U.S. Application Data
(60) Provisional application No. 61/559,311, filed on Nov. 14, 2011.

(51) Int. Cl. G06F 17/30

(52) U.S. Cl. CPC G06F 17/30002
USPC 235/375

(57) ABSTRACT

In connection with a computing device with an optical reader that may be operated by a user, a computer readable code (for example a bar code or unique image) is collected by the device, and then transmitted to a server. The user of the device may thereafter be provided with relevant, targeted, navigable on-screen information and offers based on their usage history, preferences, behavior, associations and/or the historical use and behavior of other users, as well as advertiser preferences. In sum, apparatuses, systems and methods are provided that may provide a unique way of using bar codes combined with a smart server to deliver special content to smartphones, iPads, Android tablets, and the like, as well as other devices. Positive feedback loops may be created with users, so that delivered content becomes increasingly customized (intelligent) to their special interests.

### CROSS-REFERENCE TO RELATED PATENT APPLICATION

This patent application claims priority to U.S. Provisional Application No. 61/559,311, filed Nov. 14, 2011, which is herein incorporated by reference in its entirety.

### FIELDS OF INVENTION

In various embodiments, the present invention may relate to web-based research, advertising, book publishing, infringement detection, marketing, sales and purchase processes and, more generally, to providing users through any Internet-connected computing device (with a browser and an optical scanner or camera, or the like) specific information and offers that become increasingly more customized as a result of repeated usage and the usage of others.

### SUMMARY OF INVENTION

The present invention leverages the scanning of a unique image, such as a one- or two-dimensional bar code, and an intelligent, learning serving platform to deliver relevant content to the user's browser or other suitable application in real time after the user scans the image. The use of a unique image eliminates the need for user data entry (typing). An enabled application on the user's device allows for the device to scan any code and utilize the servers, but the codes may also work with industry applications. The delivered content is made more relevant by the serving platform's unique use of the user's usage history, preferences, behavior, associations and/or the historical use and behavior of other users, as well as public data, advertiser preferences and other sources.

### BRIEF DESCRIPTION OF THE DRAWINGS

FIG. 1 depicts a public network block diagram, in one embodiment.

FIG. 2 depicts a serving environment flow diagram that may be used with respect to the present invention.

FIG. 3 are examples of displays that may be used with the present invention.

FIG. 4 is a Mandala Diagram, also referred to as an “Explorer's Wheel”, which may be used in the present invention, in one embodiment.

FIGS. 5, 6 and 7 are flow diagrams that show how the present invention may be implemented in different embodiments.

FIGS. 8a, 8b and 8c depict screen shots of displays that may be used in one embodiment of the present invention. FIG. 8a is of a SmartCodeFX enabled application operating on an iPhone, FIG. 8b is on an Android device and FIG. 8c shows the detail of a download button on an application that is not SmartCodeFX enabled.

### DETAILED DESCRIPTION

The present invention may be understood more readily by reference to the following detailed description of exemplary embodiments of the subject disclosure and to the figures and their previous and following description. Before the present systems, devices, and methods are disclosed and described, it is to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

In the present specification and in the claims which follow, reference may be made to a number of terms which shall be defined to have the following meanings: “Optional” or “optionally” means that the subsequently described event or circumstance may or may not occur, and that the description includes instances where said event or circumstance occurs and instances where it does not. As employed in this specification and annexed drawings, the terms “unit,” “component,” “interface,” “system,” “platform,” and the like are intended to include a computer-related entity or an entity related to an operational apparatus with one or more specific functionalities, wherein the computer-related entity or the entity related to the operational apparatus can be either hardware, a combination of hardware and software, software, or software in execution. One or more of such entities may also be referred to as “functional elements.”

As an example, a unit may be, but is not limited to being, a process running on a processor, a processor, an object, an executable computer program, a thread of execution, a program, a memory (e.g., a hard disc drive), and/or a computer. As another example, a unit can be an apparatus with specific functionality provided by mechanical parts operated by electric or electronic circuitry which is operated by a software or a firmware application executed by a processor, wherein the processor can be internal or external to the apparatus and executes at least a part of the software or firmware application. In addition or in the alternative, a unit can provide specific functionality based on physical structure or specific arrangement of hardware elements. As yet another example, a unit can be an apparatus that provides specific functionality through electronic functional elements without mechanical parts, the electronic functional elements can include a processor therein to execute software or firmware that provides at least in part the functionality of the electronic functional elements. An illustration of such apparatus can be control circuitry, such as a programmable logic controller.

The foregoing example and related illustrations are but a few examples and are not intended to be limiting. Moreover, while such illustrations are presented for a unit, the foregoing examples also apply to a component, a system, a platform, and the like. It is noted that in certain embodiments, or in connection with certain aspects or features thereof, the terms “unit,” “component,” “system,” “interface,” “platform” can be utilized interchangeably.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Reference will now be made in detail to the various embodiments, aspects, and features of the subject disclosure, examples of which are illustrated in the accompanying drawings. Wherever possible, the same reference numbers are used throughout the drawings to refer to the same or like parts.

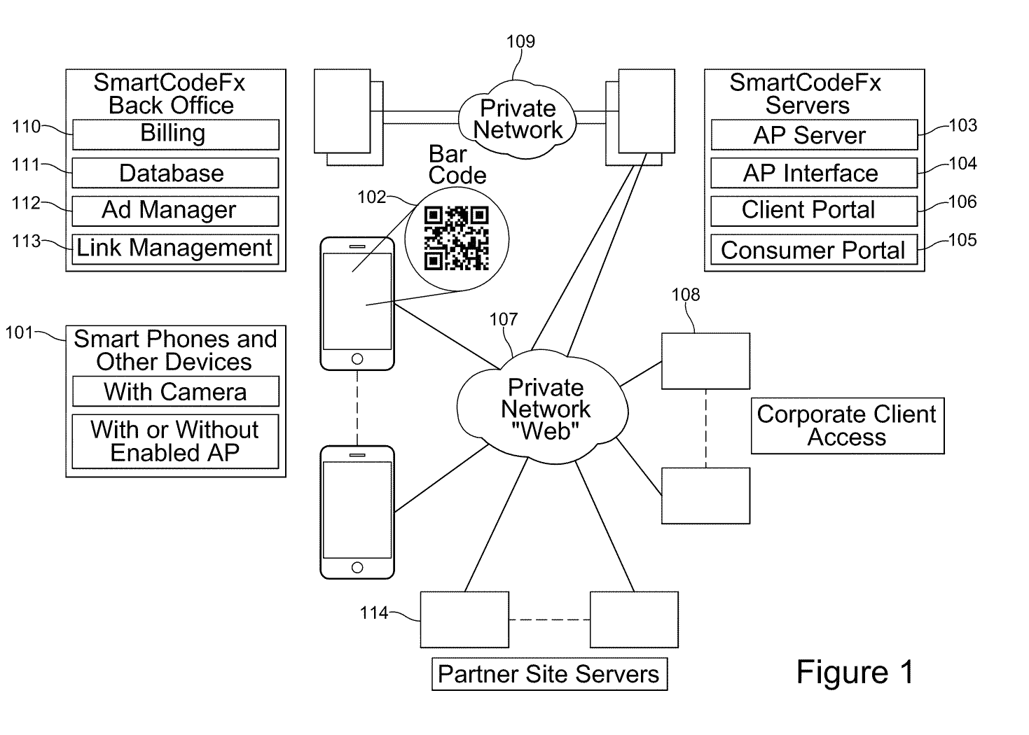

With reference to FIG. 1, a user of any smartphone (or an Internet-connected tablet, mobile device, or any other computing device) [101] with a network connection, browser, display and image scanner, such as a camera, may scan a unique image such as a bar code [102]. Such an image may comprise a QR Code. A user can scan such a code (referred to herein as “SmartCodeFx” codes) with any hardware and application combination that can scan the code. In one embodiment, a web browser may be launched with a connection to the Internet [107], as the server address may be embedded in the code.

While the codes may be encoded in a variety of ways, in one embodiment, the QR encoded text of a SmartCodeFx code could be in the following form:
‘smartcodefx.com/number’
   where smartcodefx.com is the embedded AP server address and number is a smart code identifier. The browser, using the embedded web address, may then connect with an application (AP) interface [104].

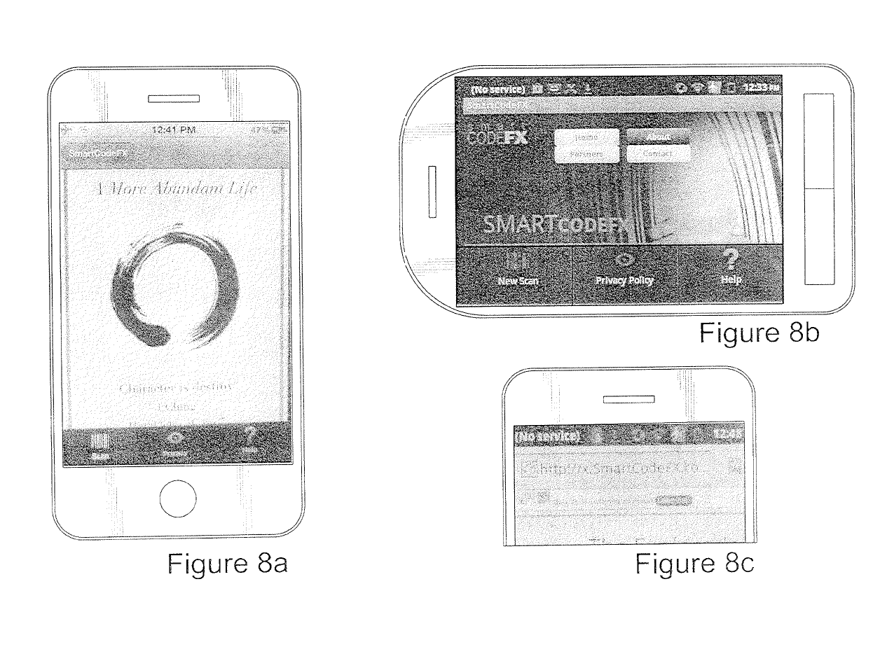

An enabled application may be used to provide further flexibility for the user. When the user utilizes an enabled application to scan an image or code, the application may connect via the Internet [107] or other means to the application interface [104] without the need for the server address to be embedded in the scanned code. The enabled application may maintain the address of the application interface [104] in order to send the scanned image or code, as well as other information, to the application interface [104]. With an enabled application, the user may utilize the system by scanning any unique image such as a standard bar code, QR Code, or another suitable code. An embedded browser may be implemented by augmenting a standard browser and scanner application with the address of the application interface. Examples of enabled applications are shown in FIG. 8a for an iPhone and FIG. 8b for an Android

A standard AP server [103] may be provided to allow for computing devices to download enabled applications. This download may be initiated by the application interface, application stores, other applications, other web sites on the public network [107] and/or manual user intervention. The consumer portal web site [105] may utilize standard servers and software to allow users to set their preferences, and the client portal [106] may be used to allow manufacturers, advertisers, stores and venues to review the data collected and billing relative to their campaigns from their corporate sites [108] via the web [107]. These servers may be implemented utilizing standard web servers and software.

For security, reliability, maintenance and scaling, the back office computers may be, in one embodiment, segregated on a private network [109]. This would help to minimize the exposure of the serving environment to the public network. Other configurations may also be utilized.

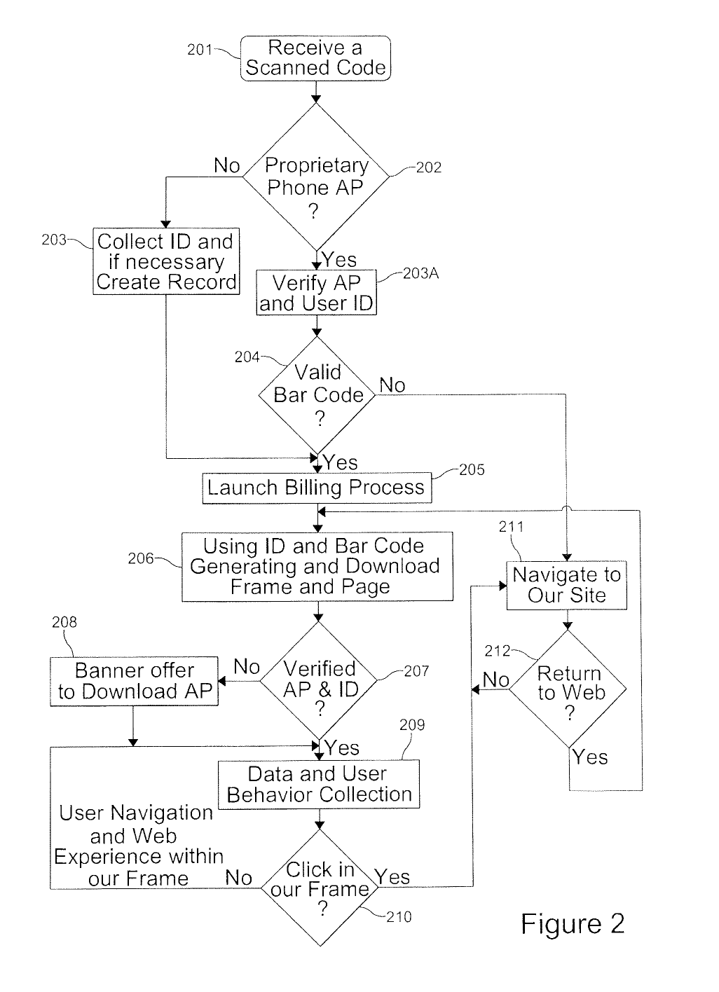

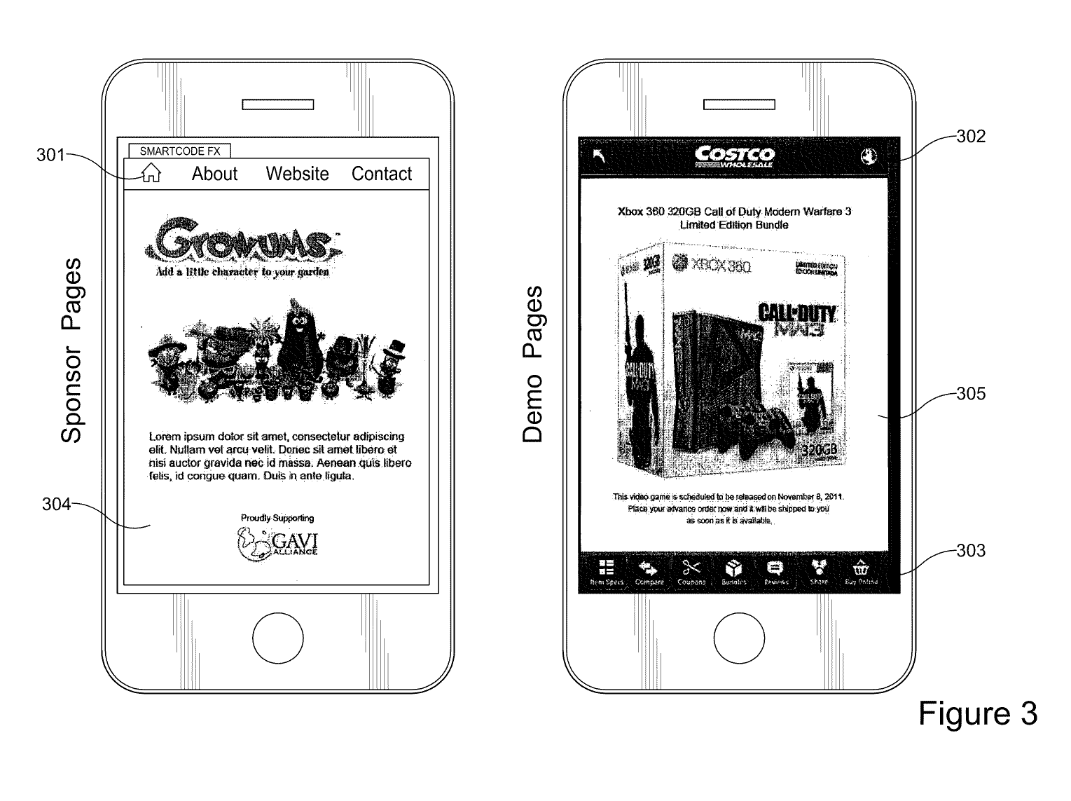

The application interface [104] implements the serving environment process (see flow diagram of FIG. 2). When the application interface [104] receives a scan [201] the server may first verify the browser application [202] as enabled or standard. The user may then be uniquely identified [203, 203A] (anonymously or opt-in based) each time a code is scanned and the scanned code is validated [204]. The process may then launch the billing process [205, 110] and using the user's historical information from the data base [111], advertising information from the ad manager [112] and the barcode [102], and may generate a web page [206] delivered to the user's browser on their smartphone [101]. The result is a customized response on the user's browser to the code scan delivered from the servers [104, 112, 113] utilizing a frame [301, 302, 303] around the edge of the user's browser display for navigation and features, as well as a central browsing area [304, 305] supported by the link management server [113], the application interface [104] and the consumer portal [105] as well as other applications and web sites on the public network [107]. Within the frame [304, 305] may be the content selected by the intelligent servers to be relevant for that specific user, scanned code and advertiser preference. The frame [301, 302, 303] may provide proprietary links and content-relevant navigation, opinion, voting and offers.

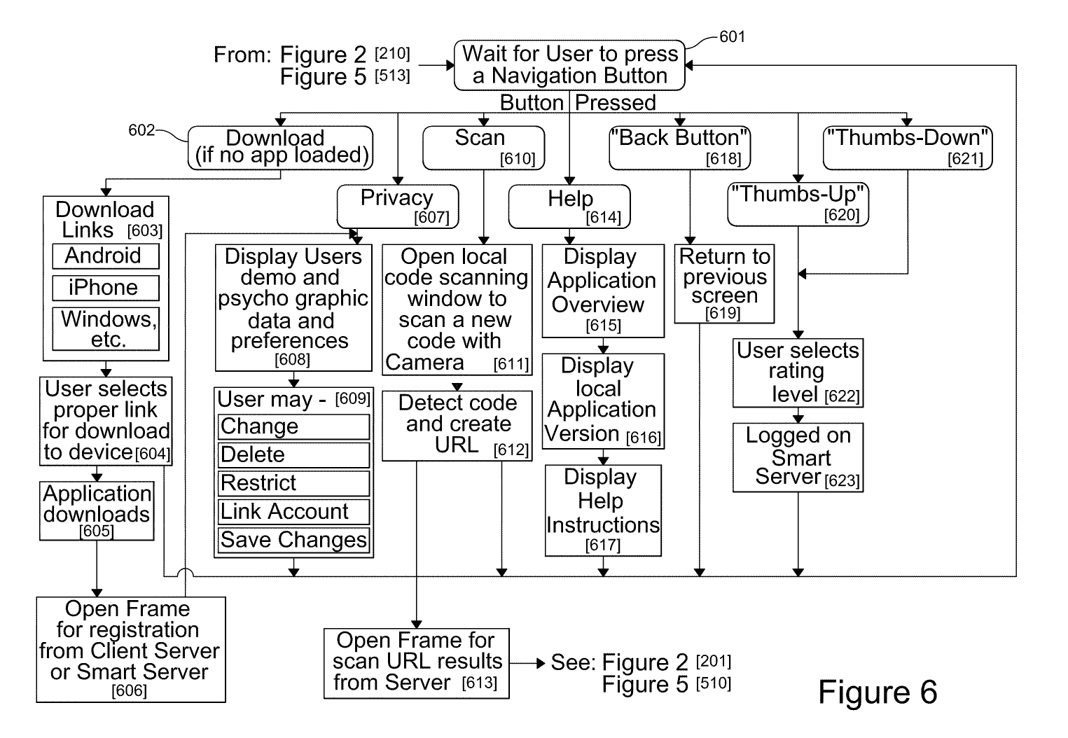

FIGS. 8a and 8b depict an example of frames supporting SmartCodeFX with a ‘Scan’ button, a ‘Privacy’ button and a ‘Help’ button. FIG. 6 discusses the flow of various buttons. Selecting the ‘Scan’ button [610] causes a camera window to open and the user to be able to align and capture a code [102]. On capturing a valid code [612], the application initiates the server processes [201, 613] and user flow [501] resulting in a served web experience displayed in the central browsing ares [304, 305]. When the ‘Privacy’ button is selected [607], the application displays the user's demographic and psychographic information held by the databases [111, 608]. The user may add, review, change, restrict or delete any information in the databases [609] as well as select a level of privacy to determine what and how their information is used by SmartCodeFX. A ‘Help’ button [614] allows the user to receive instruction on the use of the application. Additional buttons can allow voting [620, 621], navigation [618], and linking accounts.

The intelligent servers [FIG. 2] may be accessible to any user on the internet/web/cloud [107] to deliver this user browser experience in conjunction with partner web sites [114]. If the application is not SmartCodeFx-enabled [207] the servers allow the user to easily load [208] an enabled application. When a user scans a SmartCodeFX with an application that is not enabled a banner [208, 503, 8C] is displayed to encourage the user to download an enabled application. While a user is navigating [209], the AP interface [104] may collect data for the user's profile, as well as user opinion, navigation, selection, link, behavior and buying habits which may be stored on the data base server [111] for future use in generating code scan responses. The server environment continues to develop a better understanding of individual and group user behavior with each use. The servers learn more and more about each user's habits and preferences over time based on their scans, clicks, page navigation, purchases, loyalty program data, any profile updates, and other relevant information. This information may be stored in the database [111]. Similar interest patterns across the database may be identified, thereby providing more relevant responses. Based on the collected information and advertiser input, user-customized information and offers may be delivered immediately on the smartphone's (or other device's) screen [304, 305] after receiving a scanned code.

Users that scan a code with an enabled application may have access to additional features and benefits. One such feature is the ability to scan non-SmartCodeFx bar codes and images, still getting the benefit of the present application, servers and algorithms. An example would be UPC bar code scans resulting in relevant results from the servers.

The AP interface [104] implements user navigation [211] in the frame [301, 302, 303, 210] of the smartphone's [101] display allowing users to get more detailed information, see reviews, receive offers, view comparisons, visit other sites, manage their preferences [607], express opinions on items [620, 621] and web links and immediately buy products or services. The user can return to the web at any time [212].

This unique solution delivers to users specific information and offers that become increasingly more customized as a result of repeated usage as well as the usage of other users around the world.

Revenue may be derived from manufactures, distributers, publishers, advertisers, information partners, retailers, venues, etc. Product manufacturers and retailers may deliver customized decision-making information and promotional offers to shoppers before store checkout. Because the system may be cloud based, product manufacturers and retailers can make real time changes [108] as a result of inventory and/or emerging shopper reactions to information and promotional offers. Clients can also have access to the database that is developed on consumer usage, trends, habits and patterns.

There are numerous applications for the technology outside the retail environment. For example, magazine, book, and catalogue publishers can use the application and platform to deliver cloud based, customized, real time information to readers through their smartphones and Internet connected tablets. Manufacturers, retailers, and publishers have targeted, trusted web based access to consumers anywhere and anytime.

Exemplary applications of the present SmartCodeFx solutions platform are below:

### Application #1—New Publishing Model—LAMB™ (Living Adaptive Multimedia Book)

SmartCodeFx offers an enabling technology for LAMB. Below are several examples which bring readers closely “in touch” with the subjects of interest by building a bridge with the online and new media worlds. The user interface for such an application may be smart devices such as smartphones, iPads, etc. [101], coupled to the intelligent server described previously [FIG. 2], voting system [211], and other applications and web sites on the public network [107], as illustrated further in Application #2, described below.

Application #2—Learning from the Masters

Several examples of the teachings of the present invention may be illustrated from Julian Gresser's book Piloting Through Chaos: Wise Leadership/Effective Negotiation for the 21st Century (1995/revised version to be published in Q1 2012). This book is available from Bridge 21 Publications, 1111 Santa Monica Boulevard, Los Angeles, Calif.—Tel: 310-473-3396.

The book sets out an expert system on wisdom. The algorithm for encoding wisdom was developed and commercialized by Mr. Gresser in his software, The Artful Navigator (1985/written In C++/revised on-line version available Q2 2012), available from the author and from Bridge 21 Publications, 1111 Santa Monica Boulevard, Los Angeles, Calif.—Tel: 310-473-3396. The present invention may build on the teachings of this book, and may use bar codes [102] to couple the written book with the integrity system [107, 114] to deliver coaching to the smart devices of readers. For example, one section of the book refers to Abraham Lincoln and William Shakespeare. A scan by the smartphone [101] may materialize these masters of wisdom and enable the user to receive “coaching” on the core skills of gravitas, “negative capability” and resilience, which are taught in this book, and which are important in negotiation, leadership, and adapting effectively to life's stresses. The same teachings of the present invention may be used to “capture” relevant content from movies interviews, and other suitable sources, and also support a wide range of other applications. While this is being performed, the AP interface [104] may be used to collect and analyze [209] data from the users to become increasingly more intelligent, such that coaching tips, references, and other useful suggestions may be delivered to the user.

### Application #3—Beauty in Music, Art, and Aesthetics Generally

The systems and processes of the present invention may also be used with aesthetic choices. For example, if a user [101] wishes to invigorate herself or himself, she may scan a code [102] and a menu of choices may be displayed [206, 304, 305]—for example: life force, triumph, exuberance. As a result, a selection of musical compositions may be delivered from the servers to the smartphone, to be listened to by the user. The browser display [209] may explain how Beauty constellates various emotions such as bounty and generosity. A scan [101] of a SmartCodeFx code [102] may produce the last choral in Bach's first cantata, which perfectly illustrates this point.

Application #4—Explorer's Wheel (www.explorerwheel.com).

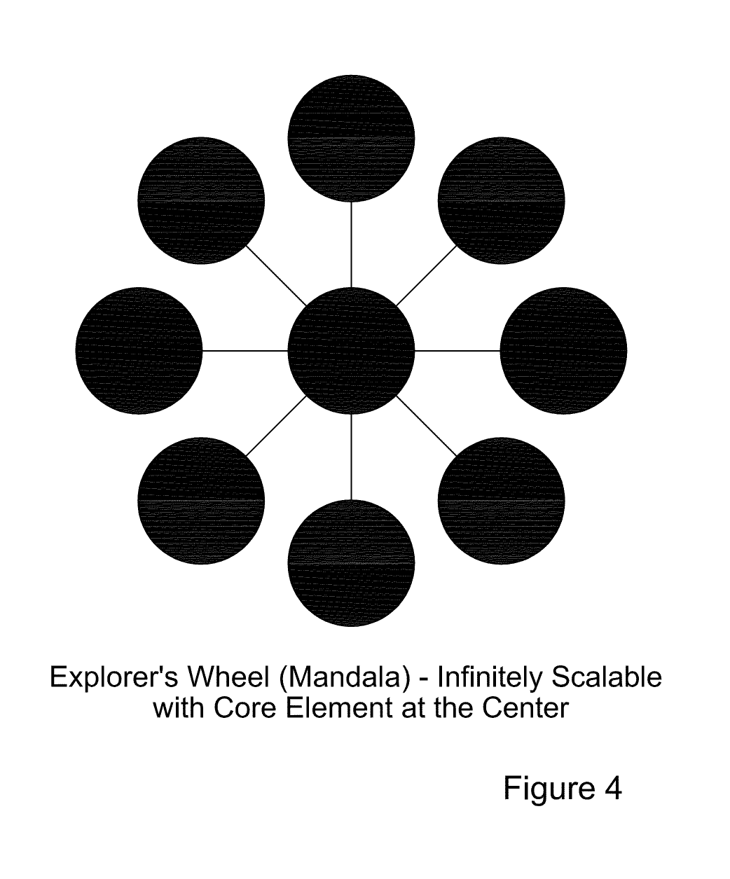

Using the algorithm of “Trust in the Connection,” as explained in the revised version of Gresser, Piloting Through Chaos (discussed above), it is possible for a reader/user to explore different diverse realms which turn out to be “connected” in various and interesting ways. For example, a Mandala Matrix, otherwise known as an Explorer's Wheel,” is shown in FIG. 4, and is derived from the Buddhist image of the 8-Foldpath. In artistic renditions this is usually depicted as a central core with eight (8) realms or quadrants around it. In the image we are depicting the title of each of these eight realms itself becomes the center of its own 8-quandrant Explorer's Wheel, and the series can be expanded infinitely. The primary benefit of the Explorer's Wheel is as a meditation tool, because the user can focus on the center or on any realm, or allow the Explorer's Wheel to resonate in the mind with all realms simultaneously. The bar code and other elements in the present invention may link the Explorer's Wheel to the Internet, and supports the integration with smart devices, databases, voting and other elements in the system. This may further enhance the individual and cumulative effects of the image as a means of stimulating creativity and innovation by linking phenomena which are not ordinarily correlated. The elements in the revised version of Piloting through Chaos which the author has selected for purposes of the Explorer's Wheel are: the Past, Future, Wisdom, Beauty, Discovery, Life Force, Paying forward to Humanity, the Networked Brain, and the Future. Linked to, for example, Wikipedia (www.wikipedia.org, or a similar encyclopedic source) and/or numerous other databases [107, 114], users can discover and be able to link “anything” with “anything” and “everything with everything.” What may enable this is the teachings of the present invention.

For example, the user may point the smart device [101] toward the Explorer's Wheel of FIG. 4, and associated codes [102] on the printed page, or any realm in it, and the same overall process as described previously with respect to the Learning from the Masters application may enable users to enter an increasingly useful and intelligent feedback loop. This feedback loop may be implemented on an independent web-based server [107, 114], in one embodiment. By utilizing the AP interface [104], user's browser [101], data collection [209] and frame features [211] it can be expanded almost infinitely as users develop their own personal Explorer's Wheels, whereby each core element they deem most significant becomes the center piece of their elaborated matrices. These personal Explorer's Wheels can then be shared and refined by contributions throughout the network, such that the personal discoveries and inventions as well as the collective work product is enhanced, all enabled by the bar code, smart device, adaptive databases, intelligent server, feedback loops, and other elements of the system, as described above.

### Application #5—Momentum and Tipping Point Accelerator

This application can be summarized by the following formula:

SmartCodeFx Platform+Social Media→Butterfly Effect+Momentum=Tipping Point

This formula expresses the following relationships: The “SmartCodeFx platform”is linked to various social media sites; here users are encouraged to “pay forward,” a form of tithing, which will trigger and accelerate the Butterfly Effect; as the Butterfly Effect gains momentum it will eventually reach a tipping point. This process can also work in reverse. A store may want to identify a tipping point a priori, and use the technology to build momentum, stimulate the Butterfly Effect, which will encourage greater dialogue through social media—all enabled on the SmartCodeFx platform.

In the context of the present invention the formula may have at least two prominent applications”:

a. Virtuous circles for the public good

b. Empowering consumers

These two application variants are described in further detail below:

a. Virtuous circles for the public good

Butterfly Rescue—The Butterfly Effect has been scientifically observed and well documented. See, for example, http://en.wikipedia.org/wiki/Butterfly_effect. The present invention may use the SmartCodeFx platform for networked tithing (described above) to enhance and accelerate this scientific phenomenon. For example, by scanning an icon of a butterfly with the smartphone [101], the user can obtain a list [206, 304, 305] of Butterfly Rescue Projects; with one click [211 or 209] the user can send a donation to a Butterfly Rescue Project. With another click [209 or 211] the user can get a daily/weekly report of on her/his smartphone of the Butterfly Effect, as a result of the collective actions of the Butterfly Network around the world. With a third click [209 or 211] the user can request a profile of others in the Butterfly Network with whom to collaborate and optimize Butterfly actions in concert. By voting and other consumer survey mechanisms [211] the server becomes increasingly intelligent and enables users to optimize their charitable activities in concert with others for maximum (Butterfly) effects.

The Butterfly Effect can be strongly enhanced by coupling it to one or more social media sites such as See Your Impact, Facebook, LinkedIn, and so forth [107, 114]. Users may share their ideas and information, vote, and dedicate funds to See Your Impact, Butterfly Rescue, and other social causes. Meanwhile, the server may be tracking and collecting data [209], and producing continuous reports on the social consequences of the Butterfly Effect in the real world.

Explorer's Wheel—The same basic process is at work with the Explorer's Wheel (FIG. 4), except for the point that a “Connecting Everything with Everything” algorithm may be used, in one embodiment, which may enable the data and feedback systems rapidly to become far more intelligent, responsive, focused, and adaptive. The mechanism on how this may implemented is described below.

b. Empowering Customers

The basic process of this application involves, for example, empowering customers in a store who become part of a “learning network,” which aims to provide customers with instantaneous and actionable intelligence on any product or service. A user can connect with relevant information via a code scan [102] and immediately receive information on screen [112, 114, 206, 304, 305]. Previous users, as well as the current user, can: rate existing links, recommend new links, provide video, audio or test reviews, comment on reviews, recommend alternative products, etc. [111, 211]. This data is collected [209, 111] and correlated so that the next person to scan this code or a code [102] with similar context gets the benefit of previous users' activities. Offers can be made that require consumer/user momentum in order to vest. An enabled application [101] may provide the inter-user platform for building momentum.

Example—Suppose Safeway (a chain of grocery stores) has an over supply of pears that are very ripe. Shoppers may be offered the opportunity via the enabled application to get additional loyalty points if enough pears are sold that day. Samples of the pears are available and users can rate and review the pears with the application, by scanning codes associated with the pears, as well as tell their friends via social networking. Consumers entering the store and scanning the store code [102] at the door also learn of the promotion. Momentum is built as consumers try to reach the tipping point.

### Application #6—Infringement Detection

The present invention may be used to enhance the reliability and effectiveness of intellectual property infringement detection.

### Example—Stage #1—Trademark Infringement Detection—

A bar code [102] linked [113] to a special web site on the web [107, 114] is embedded in a store front and in logos on a product, for example, chocolates. The web site contains special health and safety features of the product and an explanation of the precautions and maintenance of the store owner to ensure the freshness and purity of the product. The public is provided an embedded code via the bar code technology to report infringers to the local authorities. The code is changed every 15 minutes to avoid hacking and copying. The customer may scan the bar code [102], and thereafter check his/her smartphone [101] to see if a Red Infringement Flag comes up. If so, the customer is directed on her/his display [304, 305] to whom to report the infringement. The user is provided a bounty based on successful prosecution of the infringers. A quasi-game is thereby created called, “Find the Infringers!”

In one embodiment, the Infringement Detection Application may differ from the previous applications in these respects.
i. The purpose is detection not simply inter-media interaction.
ii. The data is collected not only from customers but also from manufacturers of the product or services who are enlisted into the voting/feedback process [211].
iii. The uses of the data may be different—to build a collaborative process with producers to reduce or eliminate infringement, fraud, and other anti-social behavior.
iv. A special “red flag” code is embedded and employed which is sensitive to data being fed to it by the system.
   Application #7—Store Scan (with or without an Enabled Application)

In this application, a user [101] scans a code [102] on entering a store. The browser frame [211, 301, 302, 303] is customized for the store providing unique, localized and relevant links to offers, coupons, rebates, store map, loyalty program, store credits, etc and the central display may provide a window [209] into the store's marketing server on the web [107, 112]. User web navigation and scans of any code in the store can provide answers to their questions and offers. [206, 209, 211]

Application #8—Store Shelf (with or without an Enabled Application)

In this application, a user [101] scans a code [102] on a store shelf or isle in the store. The browser frame [211, 301, 302, 303] as well as the center of the browser display [206, 304, 305] may be generated for the products in that part of the store. Relevant links [111, 112, 113] are provided to the smartphone, etc., to comparative data, reviews, offers, coupons, rebates, up-sells, cross-sells, etc as well as answers to questions and offers, with the scan of any code [102] in the area.

Application #9—UPC Scan (with an Enabled Application)

At home, in the office, on a plane, in a store, etc., a user [101] may scan a UPC code [102] and the AP interface [104] can provide [111, 112, 206] localized and relevant inventory, price, manufacturing specifications, video, reviews, consumer opinions and promotions in real time on the users browser [304, 305] while the frame [301, 302, 303] allows the user to navigate [211] these selections and buy product.

In sum, the teachings of the present invention provide a unique and powerful way of using scanned digital codes (i.e. barcodes), and allows for the delivery of targeted, relevant, trusted and behavior-based information to consumers anywhere, anytime.

### Application #10—Smart Images

In this application, image (pattern) recognition may be used, linked as explained above to smart phones and a smart server (latter discussed below). The image wherever it appears becomes a portal to connect to a Personal Learning Network (PLN). The PLN is “smart” because it is a continuous intelligent feedback loop, which learns about the individual user, and similarly situated users, who contribute to the process by standard voting procedures. The virtue of having the image appear anywhere in the external world,—for example on a billboard, on the wall of a restaurant, on tea shorts, appliances, or other products of all sorts—, as opposed to a specific printed page (ie. book) or web site, is the feedback loop is substantially augmented and stimulus to ideas and innovations is enhanced. Similarly, smart images can be embedded in videos, rendering these videos alive and turning them into portals for continuous leaning, using the same basic platform which has been described,

An example of such a “Smart Image” is a “SmartCodeFX”, as described previously in the present specification. Smart Images in one embodiment may comprise various types of bar codes, including ISBN, QR, UPC and code128. Any other type of bar codes, including 2D and 3D, etc., may also be used. The technology to recognize images other than codes is also available.

Smart Images may be implemented in various ways: (1) a picture of the item to be recognized could be captured by the smartphone, and passed to a higher capacity processor in the cloud, (2) easily recognizable elements in the image may be embedded in the images, etc.

The PLN is another exemplary application of the SmartCodeFX solutions platform of the present invention. The user interface for such an application may be smart devices such as smartphones, iPads, etc. [101], coupled to the intelligent server described previously [FIG. 2], a voting system [211], and other applications and web sites on the public network [107], as illustrated further below.

Referring again to FIGS. 1 and 2, a scan of an image by a smartphone [101] may produce images, sound and visuals of interest to the individual user based on that user's feedback. This feedback can be in the form of suggested links, voting, stories, commentary—all of which may reveal important personal information about the user which is far richer than ordinary demographic statistics. These data in turn may set up the smart feedback loops, which can elaborate in theory infinitely. While this is being performed, the AP interface [104] may be used to collect and analyze [209] data from the users to become increasingly more intelligent, such that future scans provide even more targeted information to the user. Users thereby enter an increasingly useful and intelligent feedback loop. This feedback loop may be implemented on an independent web-based server [107, 114], in one embodiment. By utilizing the AP interface [104], user's browser [101], data collection [209] and frame features [211], this process can be expanded almost infinitely as users develop their own unique “profiles.” Other users with similar ‘profiles’ benefit from the experience, information and links visited by users with common characteristics, demographics and psychographics.

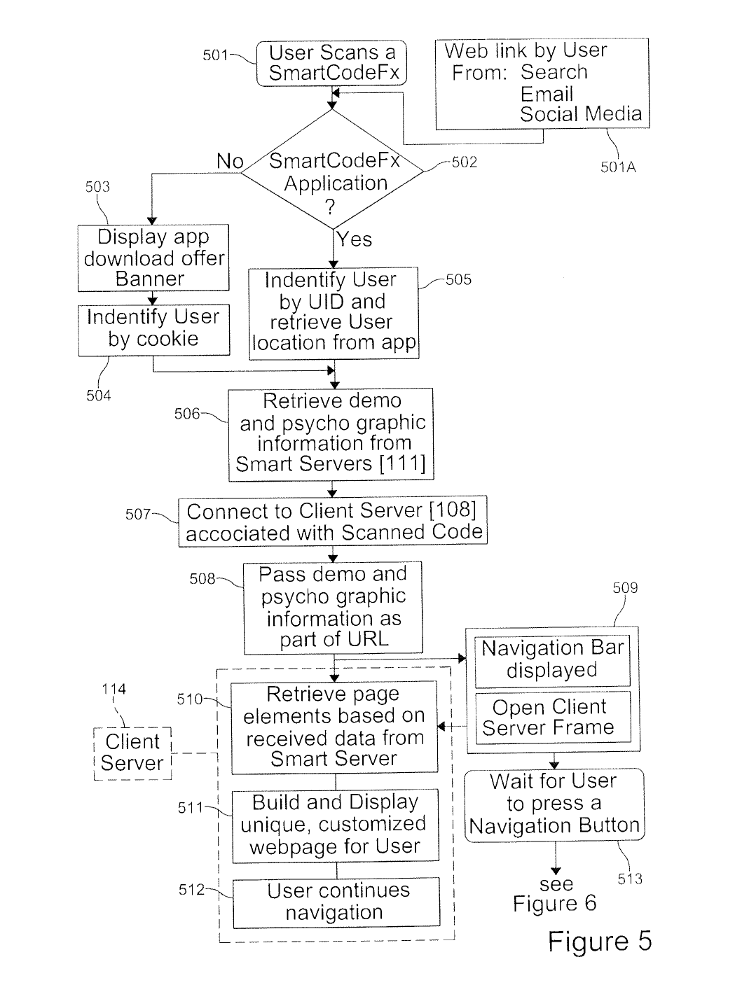

As an example, and with reference to FIGS. 1, 2, 5 and 6, suppose a potential user is dining in a restaurant and observes a Global Water Explorer's Wheel icon (image) on the literature about the restaurant. This particular restaurant may pride itself as supporting noble causes, such as delivering clean drinking water to poor people around the world. The user clicks (scans) [501, 610, 611, 612] a SmartCodeFX [102] with their smart mobile device [101]) and is taken via one of two paths [202, 502]: (1) without the SmartCodeFX application—user's browser is redirected [206, 507, 508] by the SmartCodeFX servers to the client's server with a banner [208, 503] encouraging the user to download the application [602]; or (2) with the SmartCodeFX application installed [605] a window frame in the user's browser [613] is redirected by the SmartCodeFX servers [507, 508] to the client's server with demographic and psychographic data to the smart Global Water Wheel web site. For example, on scanning a code the user's cookie [203, 504], SmartCodeFX unique ID [203A, 505] and/or location are transmitted as a part of the SmartCodeFX URL [201, 508] to retrieve this data [506] via the SmartCodeFX data base [111]) to allow the clients page to be customized [511] for display [613] to the user. The user can then register in a number of the innovation teams (the client web site can display a fully customized web screen [206, 511] to the user utilizing demographic and psychographic input from the SmartServers [510] to deliver one-to-one relevant and targeted results), or perhaps joins an innovation competition. The data the user provides to the network the client web site [512] becomes smart as the users usage and navigation are collected and automatically analyzed [209] for patterns and correlations with other users; which means that with each new click the client servers [114] are better able to deliver more relevant and targeted results, directly relevant to the specific aspects of global water issues which are of greatest interest to that user. The intelligence of the system grows because the smart servers [111] integrate contributions from thousands of users. Examples of inputs to the databases include application registration [707, 708], feedback from client web sites [106], links and votes [620, 621] offered by users. Based on our research the human brain functions as an Explorer's Mind. The moment an idea, an image, a metaphor, a meme, a pattern appears, either internally or from the external world, the mind does not remain passive; it cannot. The Explorer's Mind immediately begins to weave or spin a story; it takes a piece of information from here; other information or data from there and begins its story telling function, naturally. Indeed, it is compelled to look for and to create meaning. The SCFX process mimics and mines this story-telling capacity of our minds and brains by automating this natural phenomenon. The automatic correlations running in the background on the databases [111] identify patterns, differences and commonalities resulting in a the ability to deliver rapidly demographic and psychographic keys to the client web servers [114] at the time of a scan [508] allowing for the delivery of rich, relevet and targeted web content based on the knowledge, mind sets and preferences of thousands of users, gowing to millions with usage.

One unique feature of Smart Images of the present invention is its embodiment in the Explorer's Wheel structure. The Explorer's Wheel is both an information organizational device and an energy vortex or concentrator. Hence, an ability to make the Smart Image of the Explorer's Wheel essentially ubiquitous, will allow the PLN, or a Collaborative Innovation Network of potentially thousands of participants or more, to become increasingly connected AND with their creative energies focused on a core objective. Examples of these dedicated Explorers' Wheels include: earthquake prediction and emergency response, global water and blindness issues, creative smart sustainable cities, longevity, and a 2^{nd} Renaissance. These are all large public causes where potentially huge numbers of people can contribute. The ability to disseminate through multi-media of all forms smart images of the Explorer's Wheel will greatly enhance the awareness and effectiveness of the continuous feedback and learning process. The Explorer's Wheel application is an exemplary application of a ‘PLN’ utilizing the SmartCodeFX solutions platform as described above.

The present invention contemplates a number of a variety of embodiments of the Explorer's Wheel image, which in the Japanese language is referred to as a spiral or enso. These initial applications may include t-shirts and other clothing, kitchen ware, name cards, letterhead and other printed material, and stickers which can be placed on a wide range of applications. The goal is to turn objects in the external world into portals for contemplation and entry into the intelligent Explorer's Mind data base, which in turn through continuous feedback further enriches the explorer's experience of both the external and inner worlds.

Yet another example of the present invention, relating to global water issues, will now be described. A user visits the smart Explorer's Wheel web site (by scanning a SmartCodeFX [102, 501], searching the web or receiving a link via email or social media [501A]) and registers [606, 607, 608, 609] with the Explorer's Academy (the registration process includes questions [606] that allow a basic demographic and/or psychographic profile to be developed), then downloads the SmartCodeFx application [602]. On the registration form the participants are invited to include not just normal demographic information (gender, birth year, home zip code, and current location) but also SmartCodeFX scan count and more personal or “psychographic” information (preferences, feelings, attitudes, causes, dislikes, passions, favorite causes and vision), in this case on the subject at hand, global water issues. The user explains that she has a long standing concern about the world water crisis especially in poor countries facing significant droughts, such as India. SmartCodeFx receives about 100 similar registrations (known by the smart data base [111] through the application interface [104] and/or the client portal [106]).

The first time the user clicks [501, 602] on the Explorer's Wheel site, she receives on her smart phone [101, 206, 511] some general, although pertinent, information on global water issues, the names of leading organizations, and perhaps a featured You Tube video about water problems in rural India. She rates these data (via the SmartCodeFX navigation bar [509, 513, 601] using, for example, a scale of 1 to 10 [622], via ‘thumbs-up’ [620], ‘thumbs-down’ [621]); she may also suggest other links to the Global Water Wheel network The Global Water Wheel Network is an example of a Smart Explorer's Collaborative Innovation Network which is dedicated to achieving a specific mission: driving innovations in delivering clean and affordable water to everyone on this earth. Millions of participants using the SmartCodeFx smart platform of the present invention will be contributing together and learning together with their personal learning greatly enhanced by the smart platform and automatic feedback processes. If suggested enough times those new links would be seen by others who could rate them, thereby growing [623] the quality and quantity of content in the wheel.

The next time the user clicks [501, 610, 611, 612] the links are more directly pertinent, because the servers [108, 111] have collected more data and can better correlate with other users).This is because new users are continuously registering while existing users are commenting, contributing links, voting, developing out their backgrounds and in many other ways revealing their deeper interests and concerns. In other social networks, such as Facebook, this is done manually by users, whereas the present invention automates this process.

For example, on her registration form [606], a user may note that she has been a teacher, and is interested in new models of online education. So the next time she clicks [501, 610], she is alerted to a new program that is being formed by a group in, for example, See Your Impact (http://seeyourimpact.org/), a social entrepreneurship site. The smart technology of the present invention greatly enhances the velocity of these virtuous circles, because everyone in the Network is more actively engaged and learning. The user may register her approval [620] and this key piece of intelligence (which is learned by the servers [111, 104, 623]) can then appear on the smart phones of other members with the same interest. The intelligence of the system grows as users scan, navigate, suggest, write and vote; the smart servers integrate these contributions from all users into a common database [111]. The automatic correlations running in the background on the databases [111] identify patterns, differences and commonalities resulting in a the ability to quickly deliver demographic and psychographic keys to the client web servers [114] at the time of a scan [508] allowing for the delivery of rich, relevant and targeted web content based on the knowledge, mind sets and preferences other users.

Other areas of interest in global water could be, for example, drought, coming water crisis, water related diseases, desalination, recycling, water management, air-to-water technology, water innovators and hydro-energy projects, etc.

The user may decide to print a graphic of the Global Water Wheel and publish it broadly in India. Every person who points [501] her or his smart phone [101] at this “traveling” graphic [102] then has a portal to enter and contribute to the Network. The process becomes exponentially smarter as many people not only register their interests and preferences but also begin to tell their individual stories about how they are contributing to solving the water crisis (and suggesting content links and rating [620, 621] others). The client servers can pass any information via the client portal [106] to the Smart Servers. The smart servers [104, 106, 111] harvest this data (their stories) by recognizing key words, images, metaphors, themes, patterns, references, and other critical information which is embedded in these narratives. The intelligence of the system grows as the smart servers [111] integrate contributions from thousands of users and clients. The automatic harvesting processes running on the databases [111] in the background identify patterns, differences and commonalities thereby developing more detailed demographic and psychographic profiles allowing the client and advertising servers [114] to deliver users rich, relevant and targeted web content based on the stories, knowledge, mind sets and preferences of thousands of other users.

### Application #11—Smart Web Site

A smart web site is the alter ego of a smart phone and smart bar code and may be closely integrated with them according to the teachings of the present invention. A smart web site is made to provide the same Smart benefits to a user by implementing an industry standard ‘cookie’ to identify the user, allowing information including usage and registration to be collected by the SmartServers as previously discussed [209] and by implementing linkage between the identifiers of a single user [203, 203A] across devices (the unique user ID and/or cookie of each of the users devices) [609].

For example, suppose a user visits the following web site: www.explorerswheel.com. She fills out a Registration Form just as a mobile user does (as previously discussed) to enter the “Explorer's Academy.” The user's basic demographic data is passed from the client server [114] through the client portal [106] to the databases [111], and a list of Explorers' Wheel Initiatives is presented by the client server [114] (the Wheel web site). The visitor is invited to check the Wheels he/she is most interested in using a ‘radio button’ interface. The user is then prompted to provide a paragraph on an area that is most intriguing to her by one or two key probing questions from the Wheel web server. She is also invited to contribute web-links that may interest other participants via a drag and drop interface. The information collected is passed through the client portal [106] to the data bases. The automated algorithms can then begin the process of smart collation as previously discussed.

Over time the SmartCodeFx servers receive this information from many users of this Wheel and identifies popular themes and links producing a collection of recommended content (links), which will be displayed on the smart phones of the Wheel's users. The smart web site may be closely connected with social media sites (Facebook, LinkedIn, etc.), which serve as an amplifier of the process. In other words, the smart web site can be viewed as the pump primer; the engine is social media which provides the traffic.

With permission, the Wheel's servers can harvest a users social media likes, dislikes, links, friends and tweets. This information can then be passed to the smart database [111] via the client portal [106]. Users can control what information is available to clients via the privacy tab [607] on the application frame [8A, 8B]. The SmartCodeFx smart servers of the present invention can then automatically correlate the data identifying the most significant trends, patterns, and insights of this social media “buzz” for feedback to the Wheel's members via smart links which appear on the user's screens producing an enjoyable and enhanced learning experience.

The SmartCode environment of the present invention may utilize an application [202] for smart phones [101], as well as an application for computers, an application interface [104], a data base [111] and client access/portal [106, 108]. In the case of a SmartWebSite accessed via a computing device without the application [202] (ie desk computers arriving at a SmartWebSite via a search or link on a web page or in an email) the present invention may still create a unique user identifier using an industry standard ‘cookie’, to provide a smart experience. The client web site can collect and provide cookie and usage data to the Smart data base [111] via the client access/portal [106, 108]. The client web site can then utilize demographic and psychographic indicators retrieved from the client portal in the same way as it does with smart phones. This is accomplished as described above, thereby providing a smart one-to-one experience between the user and the client independent of the user's computing platform. Users with multiple platforms (smart phone, iPad, laptop, tablet and desktop) could link [609] their various devices into one account via the consumer portal [105] to integrate their personal date, privacy and security.

### Application #12—Early Detection and Prevention of Infringement of Copyrights and Other Intellectual Property in Smart E-Books

Millions of dollars are lost each year as a result of infringement of e-books. In fact, the situation is so bad that publishers routinely spend huge amounts of money in attempting to secure e-books from infringement (largely unsuccessfully), and as a result profit margins shrink dramatically. The present invention may be used to provide an early warning detection against such infringement, such that infringements can be reported and prevented, and systems subject to infringement can be effectively disabled.

This may be practically accomplished by the following techniques using the mechanism of a “smart” e-book. A smart e-book may have a specific code not only for each user but also for each embedded smart code in the book. Hence, if there is an attempted infringement, the smart server can instantly detect this unauthorized use, and send a notification of infringement to the author and/or publisher, and if desirable to the infringer. If the infringing user registers with the SmartCodeFx system of the present invention, the servers will have additional information which can reinforce detection and control. Smart e-books may have additional encrypted codes, which may or may not be visible to infringers. These codes can be distributed throughout the e-book making them virtually impossible to detect or disable. Once an infringement is detected, the Smart functions of the e-book will be disabled; the smart feedback system will stop; the hosting site will be alerted, and a notification will be sent throughout the network.

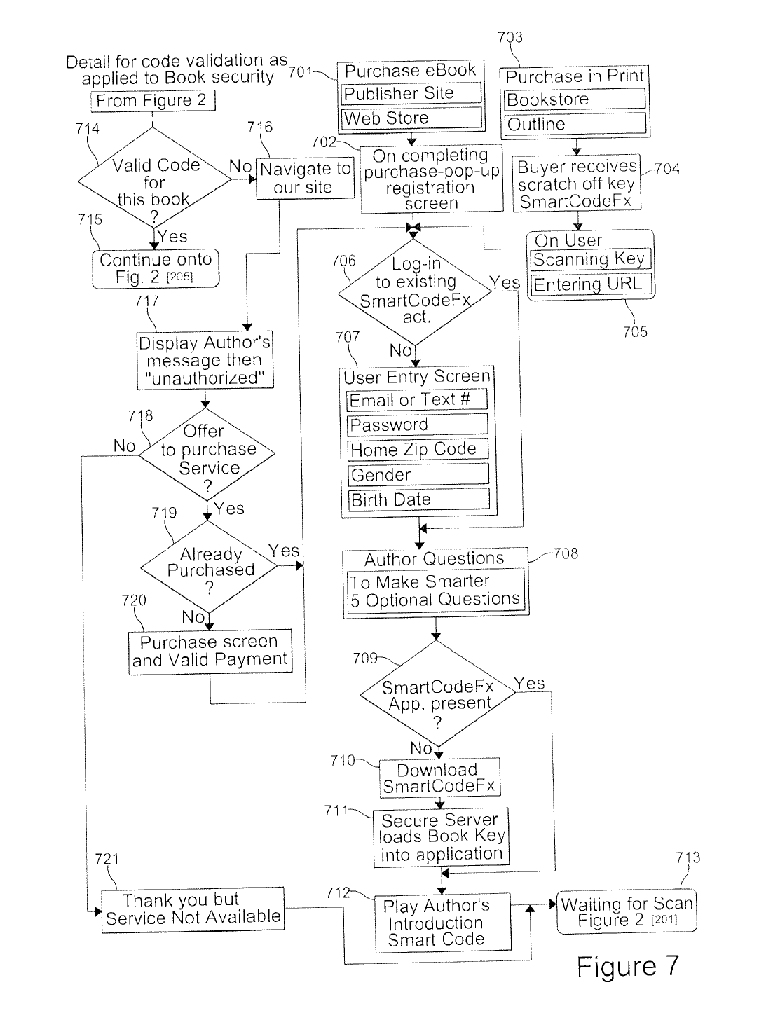

With reference to FIG. 7, one such implementation could be: a reader (user) purchasing a Smart eBook on line [701] sees a pop-up registration screen [702] after completing their purchase. For print books [703] the buyer receives a scratch-off key [704] with the purchase of the book and can enter a URL or scan the key to initiate the pre-paid registration. If the user does not have a SmartCodeFX account [706], she is prompted to register [707] by accepting terms and conditions and supplying an email address or text enabled telephone number, password, home zip code, gender and birth date (this information is passed to the database [111] to start the Smart learning process). Users with a SmartCodeFX account are asked to log-in with their id and password [706]. All users are then asked a certain number of questions (say up to 5, in one embodiment) developed by the author or publisher [708] to further seed smart learning and enhance security. Example questions could include: birth city, favorite author, favorite music, favorite hobby, number of children, etc. If a SmartCodeFX enabled application is present [709] the book key will be loaded [711] and the user will be presented with the author's introduction [712]. If an enabled application is not present [709] on the user's device, the application download screen [603] is presented to the user for acceptance [604]. After the application is loaded and enabled the author's introduction [712] will be presented. The SmartCodeFX servers [104] will not deliver [714, 716] content to users who have not successfully registered the book to their account. Instead the reader will see an author's message followed by an ‘unauthorized’ screen 716, 717] with an offer to purchase service [718].

The various embodiments of the present systems and methods can be operational with numerous other general purpose or special purpose computing system environments or configurations. Examples of well-known computing systems, environments, and/or configurations that can be suitable for use with the systems and methods comprise, but are not limited to, personal computers, server computers, laptop devices or handheld devices, and multiprocessor systems. Additional examples comprise wearable devices, mobile devices, set top boxes, programmable consumer electronics, network PCs, minicomputers, mainframe computers, distributed computing environments that comprise any of the above systems or devices, and the like.

The processing effected in the disclosed systems and methods can be performed by software components. The disclosed systems and methods can be described in the general context of computer-executable instructions, such as program modules, being executed by one or more computers or other computing devices. Generally, program modules comprise computer code, routines, programs, objects, components, data structures, etc., that perform particular tasks or implement particular abstract data types. The disclosed methods also can be practiced in grid-based and distributed computing environments where tasks are performed by remote processing devices that are linked through a communications network. In a distributed computing environment, program modules can be located in both local and remote computer storage media including memory storage devices.

While the systems, devices, apparatuses, protocols, processes, and methods have been described in connection with exemplary embodiments and specific illustrations, it is not intended that the scope be limited to the particular embodiments set forth, as the embodiments herein are intended in all respects to be illustrative rather than restrictive. Unless otherwise expressly stated, it is in no way intended that any protocol, procedure, process, or method set forth herein be construed as requiring that its acts or steps be performed in a specific order. Accordingly, in the subject specification, where description of a process or method does not actually recite an order to be followed by its acts or steps or it is not otherwise specifically recited in the claims or descriptions of the subject disclosure that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

It will be apparent to those skilled in the art that various modifications and variations can be made in the subject disclosure without departing from the scope or spirit of the subject disclosure. Other embodiments of the subject disclosure will be apparent to those skilled in the art from consideration of the specification and practice of the subject disclosure as disclosed herein. It is intended that the specification and examples be considered as non-limiting illustrations only, with a true scope and spirit of the subject disclosure being indicated by the following claims.

1. A system for delivering increasingly intelligent content to users of a plurality of remote devices, comprising:
(a) a receiver for receiving a code and an identifier from a selected one of the plurality of remote devices, the code being associated with an image captured by the selected remote device, and the identifier being associated with the selected remote device;
(b) a database for storing a plurality of codes and a plurality of identifiers received from the receiver, each of the plurality of codes being associated with one of the plurality of identifiers that identifies the remote device that captured the code; and
(c) a processor for performing the steps of:
i. storing the received code in the database, as one of the plurality of codes,
ii. storing the received identifier in the database, as one of the plurality of identifiers,
iii. generating content based on a history of codes of the plurality of codes stored in the database associated with the selected remote device, and
iv. transmitting the generated content to the selected remote device.

2. The system of claim 1, wherein the selected remote device displays the content for the user associated with the selected remote device.

3. The system of claim 1, wherein the image comprises a bar code.

4. The system of claim 1, wherein the image comprises a QR Code.

5. The system of claim 1, wherein the generated content comprises advertising content.

6. The system of claim 1, wherein the generated content comprises content suitable for display around the edge of a browser display.

7. The system of claim 1, wherein the processor generates the content based on a selected code of the plurality of codes stored in the database, wherein the selected code was previously received by the receiver from more than one of the plurality of remote devices.

8. The system of claim 1, wherein the code received by the receiver forms an image comprising an explorer's wheel.

9. A method for delivering increasingly intelligent content to users of a plurality of remote devices, comprising:
receiving a code and an identifier from a selected one of the plurality of remote devices, the code being associated with an image captured by the selected remote device, and the identifier being associated with the selected remote device;
storing the received code in a database, as one of a plurality of codes;
storing the received identifier in the database, as one of a plurality of identifiers, each of the plurality of codes being associated with one of the plurality of identifiers that identifies the remote device that captured the code;
generating content based on a history of codes of the plurality of codes stored in the database associated with the selected remote device, and
transmitting the generated content to the selected remote device.

10. The method of claim 9, further comprising the method of causing the selected remote device to display the content for the user associated with the selected remote device.

11. The method of claim 9, wherein the image comprises a bar code.

12. The method of claim 9, wherein the image comprises a QR Code.

13. The method of claim 9, wherein the generated content comprises advertising content.

14. The method of claim 9, wherein the generated content comprises content suitable for display around the edge of a browser display.

15. The method of claim 9, wherein the generating step comprises generating the content based on a selected code of the plurality of codes stored in the database, wherein the selected code was previously received by the receiver from more than one of the plurality of remote devices.

16. The method of claim 9, wherein the code received by the receiver forms an image comprising an explorer's wheel.
